(19) United States
(12) Patent Application Publication
(10) Pub. No.: US 2018/0288616 A1
(43) Pub. Date: Oct. 4, 2018

(54) PREDICTIVE PERMISSIONING FOR MOBILE DEVICES

(71) Applicant: The Fin Exploration Company, San Francisco, CA (US)

(72) Inventor: Matt Knox, San Francisco, CA (US)

(73) Assignee: The Fin Exploration Company, San Francisco, CA (US)

(21) Appl. No.: 15/472,163

(22) Filed: Mar. 28, 2017

(51) Int. Cl. H04W 12/08; G06N 99/00; G06N 5/04; G06N 3/00

(52) U.S. Cl. CPC H04W 12/08; G06N 3/006; G06N 5/04; G06N 99/005

(57) ABSTRACT

Methods, systems, and apparatus, including computer programs encoded on computer storage media, for predicting mobile device permissions. One of the methods includes receiving a request from a user of a mobile device, the request defining a task to be carried out on behalf of the user by a virtual assistant application installed on the mobile device; determining, by processing data characterizing the task using one or more machine learning models, one or more mobile device permissions that will likely need to be granted by the user in order for the virtual assistant application to carry out the task; and causing a prompt to be presented on the mobile device that allows the user to grant the one or more permissions.

### BACKGROUND

This specification generally relates to permissioning for mobile device applications.

Many mobile devices and mobile device operating systems restrict mobile applications installed on the mobile device from performing certain actions if the user of the mobile device has not explicitly given the mobile application permission to perform the action. Examples of actions that might require permission include accessing certain functionality of the mobile device, e.g., taking an image or video using the device camera, using the device microphone, and so on, or accessing certain data stored on the mobile device or in user accounts remote from the mobile device, e.g., a gallery of the user's photos, the user's contact list, the data stored in certain locations in memory of the device or on removable storage.

To receive the user's permission to perform these actions, the user is typically prompted at the time of installation or download of a mobile application to grant certain permissions to the mobile application or a remote server interacting with the mobile application that allows the application or the server to perform certain actions, prompted whenever a mobile application or the remote server is performing an action that it does not have permission to perform to grant the application or server permission to perform the action, or both.

User permission is also often required for a third-party service, e.g., a mobile application on a mobile device or a web-based service remote from the mobile device, to perform actions on the user's behalf using another remote service. For example, permission is required for a third-party service to access and take action on the user's behalf with user accounts for web-based or cloud-based services, e.g., sending an e-mail from the user's e-mail account using an e-mail service, creating a calendar entry or sending a calendar invite as the user using a calendaring service, making a travel or restaurant reservation as the user using a reservation booking service, and so on.

To receive the user's permission to perform these actions, the user is typically prompted to grant the third-party service permission at least the first time that the action needs to be performed by the third-party service, e.g., by prompting the user to log-in to their account with the remote service and to authorize the third-party service to perform the action.

### SUMMARY

In general, one innovative aspect of the subject matter described in this specification can be embodied in methods that include the actions of receiving a request from a user of a mobile device, the request defining a task to be carried out on behalf of the user by a virtual assistant application installed on the mobile device; determining, by processing data characterizing the task using one or more machine learning models, one or more mobile device permissions that will likely need to be granted by the user in order for the virtual assistant application to carry out the task; and causing a prompt to be presented on the mobile device that allows the user to grant the one or more permissions.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

Determining one or more permissions can include processing data characterizing the task using each of a plurality of permission-specific machine learning models, wherein each permission-specific machine learning model corresponds to a different mobile device permission, and wherein each permission specific-machine learning model has been trained to receive the data characterizing the task and to process the data characterizing the task to generate a permission score that represents a likelihood that the corresponding mobile device permission will need to be granted by the user in order for the virtual assistant application to carry out the task; and selecting, based on the permission scores for the corresponding mobile device permissions, one or more of the corresponding mobile device permissions as mobile device permissions that will likely need to be granted by the user.

The actions can further include training each of the plurality of permission-specific machine learning models, which includes, for each permission-specific machine learning model: identifying tasks that have been carried out on behalf of users; determining, for each performed task, whether the corresponding mobile device permission was required to carry out the task; and training the permission-specific machine learning model to generate accurate permission scores for the corresponding mobile device permission using, as positive training examples, the performed tasks that required the permission to be granted and, as negative examples, the performed tasks that did not require the permission to be granted.

Determining, for each performed task, whether the corresponding mobile device permission was required to carry out the task, can include: determining, from metadata associated with the performed task, whether the corresponding mobile device permission was required to carry out the task.

Determining one or more mobile device permissions can include: processing data characterizing the task using a permission profile machine learning model, wherein the permission profile machine learning model has been trained to process the data characterizing the task to generate a respective profile score for each permission profile in a set of permission profiles, wherein each permission profile includes a different combination of permissions, and wherein the respective profile score for each of the permission profiles represents a likelihood that the permission profile most accurately reflects the permissions that will be necessary to carry out the task; and determining, based on the profile scores, which permission profile most accurately reflects the permissions that will be necessary to carry out the task.

The actions can also include training the permission profile machine learning model, which includes: identifying tasks that have been carried out on behalf of users; determining, for each performed task, the permission profile that should be identified as a best-fitting permission profile by the permission profile machine learning model; and training the permission profile machine learning model to generate accurate profile scores on the performed tasks.

The data characterizing the task can include text of the request submitted by the user.

The subject matter described in this specification can be implemented in particular embodiments so as to realize one or more of the following advantages. By predicting permissions and asking a user to grant permissions that relate to a task request, the user may be more likely to grant the permissions, improving the operation of a virtual assistant application. By not needing to ask users for permissions whenever the virtual assistant application is performing an action that it does not have permission to perform and instead predicting permissions that may be necessary ahead of time, the user experience of a user of a virtual assistant application may be improved. By not prompting a user at the time of installation or download of the virtual assistant application to grant an exhaustive list of permissions, the user is less likely to be overwhelmed and may be given a better understanding of what permissions are necessary during the operation of the virtual assistant application. A synthesized and human-readable rationale can effectively be generated for why a particular set of permissions is necessary to perform a task on the user's behalf.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example predictive permissioning system.

FIG. 2 is a flowchart of an example process for predicting the permissions that will be necessary to carry out a task using a set of permission-specific machine learning models.

FIG. 3 is a flowchart of an example process for training a permission-specific machine learning model.

FIG. 4 is a flowchart of an example process for predicting the permissions that will be necessary to carry out a task using a permission profile machine learning model.

FIG. 5 is a flowchart of an example process for training a permission profile machine learning model.

Like reference numbers and designations in the various drawings indicate like elements.

### DETAILED DESCRIPTION

This specification generally describes a predictive permissioning system that predicts the permissions that will be required to be granted in order for a virtual assistant service to carry out a task on behalf of a user of the mobile device.

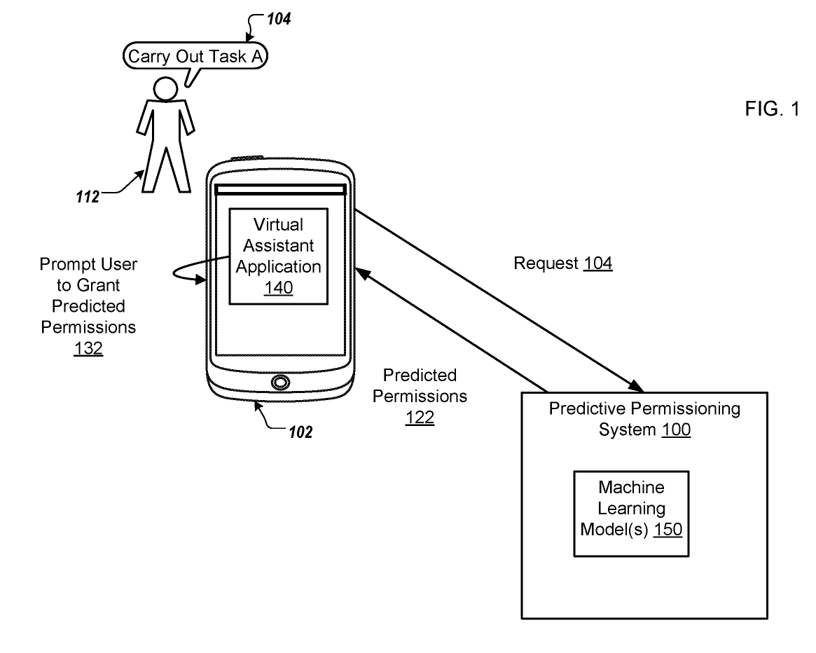

FIG. 1 shows an example predictive permissioning system 100. The predictive permissioning system 100 is an example of a system implemented as computer programs on one or more computers in one or more locations, in which the systems, components, and techniques described below can be implemented.

In some implementations, the predictive permissioning system 100 is implemented as one or more computer programs on a mobile device 102. In some other implementations, the predictive permissioning system 100 is implemented on one or more computers remote from the mobile device 102, e.g., on one or more server computers. In these implementations, the predictive permissioning system 100 communicates with the mobile device 102 through a wired or wireless data communication network, e.g., local area network (LAN) or wide area network (WAN), e.g., the Internet, or a combination of networks, any of which may include wireless links.

The predictive permissioning system 100 predicts the permissions that will be required to carry out task requests submitted by a user 112 of the mobile device 102 to a virtual assistant service. In some implementations, the functionality of the virtual assistant service is implemented as a virtual assistant application 140 running on the mobile device 102. In other implementations, the functionality of the virtual assistant service is also implemented in part on one or more remote servers that communicate with the virtual assistant application 140 through a data communication network.

The mobile device 102 can be, e.g., a smartphone, a tablet computer, or a different portable computing device.

The virtual assistant application 140 is an application that carries out tasks on behalf of a user, either locally on the mobile device 102 or by communicating with one or remote servers. Examples of tasks may include scheduling a meeting for the user, making travel plans for the user, setting reminders for the user, and many others. The tasks may include simple tasks, e.g., make a restaurant reservation at a particular restaurant at a particular time, or compound tasks made up of multiple simple tasks, e.g., find a restaurant close to my location, contact my friends to see which of them is available, and make a restaurant reservation for the appropriate number of people at the restaurant that was found to be close to my location.

In particular, the virtual assistant application 140 receives inputs submitted by users requesting tasks to be carried out on behalf of the user, generates task requests to be carried out on behalf of the users, or both, and causes the requested tasks to be performed, e.g., by interacting with remote human agents that carry out the tasks on the user's behalf, using artificial intelligence techniques, using a combination of the two, or using any other appropriate technique.

Generally, the virtual assistant application 140 allows the user to submit natural language inputs specifying tasks to be carried out by the virtual assistant application 140 using any appropriate input modality. For example, the user can submit a textual input to the virtual assistant application 140 using any appropriate text input modality supported by the mobile device 102, e.g., touch input or keyboard input. As another example, the virtual assistant application 140 can receive a voice input and convert the voice input to text in order to the process the input.

The operating system running on the mobile device 102 restricts mobile applications installed on the mobile device or third-party services from performing certain actions if the user of the mobile device has not explicitly given the mobile application permission to perform the action. Examples of actions that might require permission from the user include accessing certain functionality of the mobile device, e.g., taking an image or video using the device camera, using the device microphone, and so on, and accessing certain data stored on the mobile device.

Similarly, remote services used by the user of the mobile device restrict access to the functionality provided by the services by third-party services on the user's behalf unless the user has explicitly given the third-party service permission to access the functionality. Remote services are web-based services that offer functionality that resides on or more remote servers and that is accessed by the user through the mobile device 102 or another user device, e.g., using a web browser or a special-purpose mobile application. Examples of remote services include a web-based e-mail service, a web-based calendar service, a web-based travel booking service, and so on. Examples of actions that might be carried out as part of performing a task and that might require permission from the user include sending an e-mail from the user's e-mail account using an e-mail service, creating a calendar entry or sending a calendar invite as the user using a calendar service, making a travel or restaurant reservation as the user using a reservation booking service, and so on.

The term “mobile device permission,” as used in this specification, refers to a permission required either by the operating system of the mobile device or by a remote service in order to allow an action to be performed on behalf of the user by a third party.

Because the virtual assistant application 140 may perform many different kinds of tasks on behalf of the user that require the virtual assistant application 140 or another party associated with the virtual assistant application to perform many different kinds of actions that require permission from the user, asking a user to grant the virtual assistant application 140 permission for all possible actions the virtual assistant application 140 may need to perform at the time of installation or download of the virtual assistant application 140 may not be possible or may overwhelm the user at installation or download time. At the same time, asking the user to grant permission each time the application 140 or the other party needs to perform a particular action that requires permission while carrying out a task may be bothersome to the user and adversely impact the user experience with the virtual assistant application 140.

Instead, when a task request 112 is received, the predictive permissioning system 100 predicts the permissions that will likely be required for the virtual assistant application 140 to carry out the requested task. The predictive permissioning system 100 can then cause the user to be prompted to grant the likely permissions, e.g., by instructing the virtual assistant application 140 to present the prompt to the user 112 on the mobile device 102, by instructing the virtual assistant application 140 to cause the mobile device 102 to navigate to a web page that allows the user to grant access to a particular remote service, by sending a request to the operating system of the mobile device 102 to prompt the user to grant the likely permissions, and so on.

Generally, the predictive permissioning system 100 predicts permissions using one or more machine learning models 150.

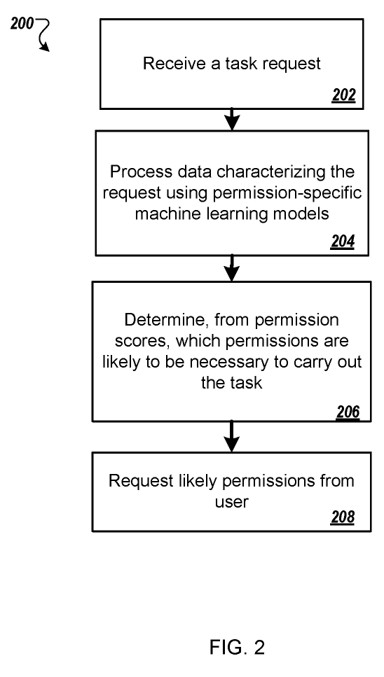

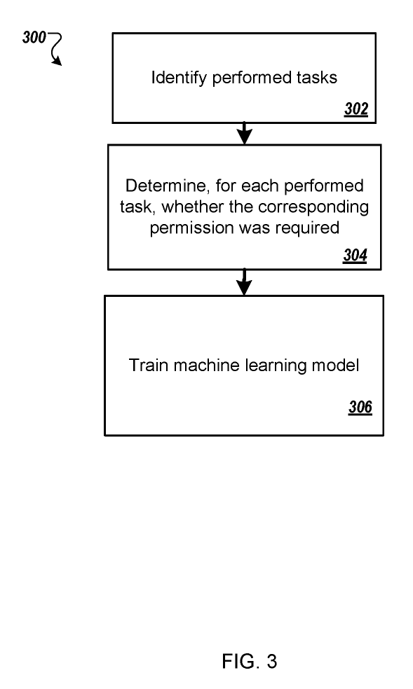

In some implementations, the one or more machine learning models 150 are a set of permission-specific machine learning models, with each permission-specific machine learning model corresponding to a different permission. Each permission-specific machine learning model has been trained to process the data characterizing a task request to generate a permission score for the corresponding permission that represents a likelihood that the corresponding permission will be required in order for the virtual assistant application 140 to carry out the task on behalf of the user. Predicting permissions using permission-specific machine learning models and training the permission-specific machine learning models are described below with reference to FIGS. 2 and 3, respectively.

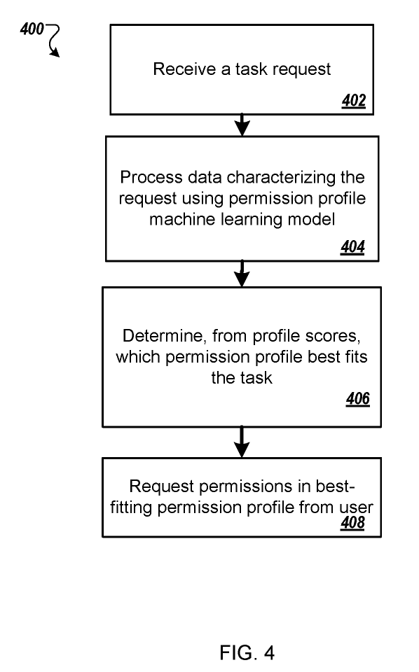

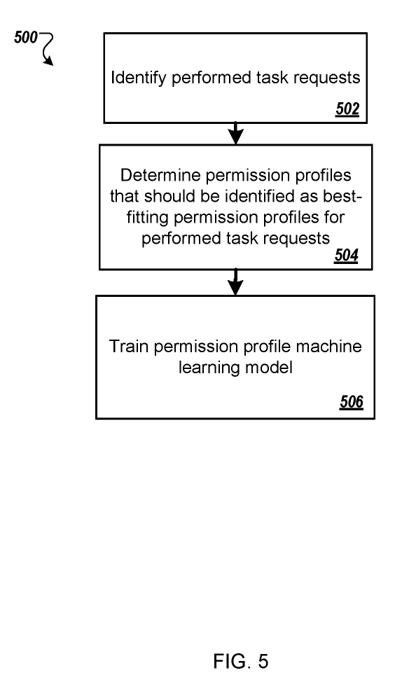

In some other implementations, the one or more machine learning models 150 are a single machine learning model that has been trained to generate a respective profile score for each permission profile in a set of permission profiles. Each permission profile in the set includes a different combination of permissions from each other permission profile and the permissions score for a given permission profile represents a likelihood that the permission profile is the best fit for the requested task. Predicting permissions using a permission profile machine learning model and training the permission profile machine learning model are described below with reference to FIGS. 4 and 5, respectively.

In one example, the user 112 submits a request 104 to “Carry Out Task A”, e.g., to make a restaurant reservation, make travel plans, schedule a meeting, or set a reminder, to the virtual assistant application 140, which transmits the request 104 to the predictive permissioning system 100. The predictive permissioning system 100 predicts the permissions that will likely be required in order for the virtual assistant application 140 to carry out Task A using the one or more machine learning models 150 and provides data identifying the predicted permissions 122 to the virtual assistant application 140. The virtual assistant application 140 then causes a prompt 132 to be displayed to the user requesting the predicted permissions before any of the permissions become necessary, e.g., before the virtual assistant application 140 begins to carry out the task. For example, the prompt 132 may identify to the user that the requested permissions are the permissions that will likely need to be granted in order for the virtual assistant application 140 to carry out the task and ask the user to grant the requested permissions.

FIG. 2 is a flowchart of an example process 200 for predicting the permissions that will be necessary to carry out a task using a set of permission-specific machine learning models. For convenience, the process 200 will be described as being performed by a system of one or more computers, located in one or more locations, and programmed appropriately in accordance with this specification. For example, a predictive permissioning system, e.g., the predictive permissioning system 100 of FIG. 1, appropriately programmed, can perform the process 200.

The system receives a task request (step 202). As described above, the task request is a request submitted by a user of a mobile device to a virtual assistant application running on the mobile device to have a virtual assistant carry out a particular task on behalf of the user. In implementations where the process 200 is being performed by the mobile device, the system can receive the task request as it is submitted to the virtual assistant application. In implementations where the process 200 is being performed by a system that is remote from the mobile device, e.g., on a system of one or more server computers, the virtual assistant application can forward the submitted request to the system over a network.

The system processes data characterizing the task request using each machine learning model in a set of permission-specific machine learning models (step 204).

Each of the permission-specific machine learning models corresponds to a different permission and has been trained to process the data characterizing the task request to generate a permission score for the corresponding permission. The permission score represents a likelihood that the corresponding permission will be required in order for the virtual assistant to carry out the task on behalf of the user.

The data characterizing the task request includes the text of the task request and, optionally, other features of the task request, e.g., the time the task request was submitted, location of the mobile device when the request was submitted, text of previous requests submitted by the user, and so on. The features of the task request can also include features characterizing user preferences of the user, e.g., that certain tasks should always be performed in a certain way for the user.

In some implementations, the permission-specific machine learning models are regression, e.g., logistic regression models or generalized linear models. In other implementations, the permission-specific models are deep neural networks, e.g., feed-forward neural networks or recurrent neural networks, e.g., long short-term memory (LSTM) neural networks.

Training the permission-specific machine learning models is described below with reference to FIG. 3.

The system determines, from the permission scores for the permissions, which permissions are likely to be necessary to carry out the task (step 206). For example, the system can identify each permission that has a permission score that exceeds a predetermined threshold value as likely or identify a predetermined number of permissions having the highest permission scores as likely.

The system causes the user of the mobile device to be prompted to grant the likely permissions (step 208). In some cases, the user may have already granted some of the likely permissions, e.g., when submitting an earlier request or at download or install time of the virtual assistant application. If any of the permissions have already been granted, the system can refrain from prompting the user to grant those permissions again or can identify in the prompt the permissions that will likely be necessary but have already been granted and therefore do not need to be granted again.

FIG. 3 is a flowchart of an example process 300 for training a permission-specific machine learning model. For convenience, the process 300 will be described as being performed by a system of one or more computers, located in one or more locations, and programmed appropriately in accordance with this specification. For example, a predictive permissioning system, e.g., the predictive permissioning system 100 of FIG. 1, appropriately programmed, can perform the process 300.

The system can perform the process 300 for each permission-specific machine learning model in the set of permission-specific machine learning models to train the models to generate accurate permission scores for the corresponding permissions.

The system receives data identifying tasks that have been performed on behalf of users of the virtual assistant application (step 302). For example, the system can access logs of performed tasks to identify the tasks and to obtain data characterizing each task, i.e., data that is of the same type as the inputs to the permission-specific machine learning model.

The system determines, for each identified performed task, whether the corresponding permission was required in order to perform the task (step 304).

In some implementations, the system logs identify, for each request, whether the corresponding permission was required.

In some other implementations, the system logs include other metadata describing the performed tasks and the system determines whether the corresponding permission was required from the metadata.

For example, in some cases, the metadata identifies actions performed by the virtual assistant application as part of performing each task, e.g., sending an e-mail, creating a calendar entry, accessing particular data stored on the mobile device, and so on. In these cases, the system maintains mapping data that specifies, for each action, the permissions that are required in order to perform the action. For each performed task, the system then uses the mapping data to determine whether the actions identified in the metadata would have required the corresponding permission.

As another example, in some cases, the metadata identifies one or more types for each request, e.g., restaurant reservation request, meeting scheduling request, and so on. In these cases, the system maintains mapping data that specifies, for each request type, the permissions that are required in order to carry out requests of that type. For each performed task, the system then uses the mapping data to determine whether the types identified in the metadata would have required the corresponding permission.

The system trains the permission-specific machine learning model to generate accurate permission scores using, as positive training examples, the performed tasks that required the permission to be granted and, as negative examples, the performed tasks that did not require the permission to be granted (step 306). The system can train the permission-specific machine learning model on the positive and negative examples using an appropriate machine learning training technique for the type of model. For example, when the model is a feedforward neural network, the system can train the neural network using a stochastic gradient descent technique. As another example, when the model is a recurrent neural network, the system can train the recurrent neural network using a backpropagation through time training technique or a backpropagation through time with Connectionist Temporal Classification technique.

FIG. 4 is a flowchart of an example process 400 for predicting the permissions that will be necessary to carry out a task using a permission profile machine learning model. For convenience, the process 400 will be described as being performed by a system of one or more computers, located in one or more locations, and programmed appropriately in accordance with this specification. For example, a predictive permissioning system, e.g., the predictive permissioning system 100 of FIG. 1, appropriately programmed, can perform the process 400.

The system receives a task request (step 402). As described above, the task request is a request submitted by a user of a mobile device to a virtual assistant application running on the mobile device to have a virtual assistant carry out a particular task on behalf of the user. In implementations where the process 400 is being performed by the mobile device, the system can receive the task request as it is submitted to the virtual assistant application. In implementations where the process 400 is being performed by a system that is remote from the mobile device, e.g., on a system of one or more server computers, the virtual assistant application can forward the submitted request to the system over a network.

The system processes data characterizing the task request using a permission profile machine learning model (step 404).

The permission profile machine learning model is a model that has been trained to process the data characterizing the task request to generate a respective profile score for each permission profile in a set of permission profiles. Each permission profile includes a different combination of permissions and the profile score for a given permission profile represents a likelihood that the given permission profile most accurately reflects the permissions that will be necessary to carry out the task.

The data characterizing the task request includes the text of the task request and, optionally, other features of the task request, e.g., the time the task request was submitted, location of the mobile device when the request was submitted, text of previous requests submitted by the user, and so on.

In some implementations, the machine learning model is a multi-class regression model, e.g., multi-class logistic regression model, or a Bayes classifier. In other implementations, the model is a deep neural network, e.g., feed-forward neural network or recurrent neural network, e.g., long short-term memory (LSTM) neural network.

Training the permission profile machine learning model is described below with reference to FIG. 5.

The system determines, from the profile scores for the permission profiles, which permission profile most accurately reflects the permissions that will be necessary to carry out the task (step 406). For example, the system can identify the highest-scoring permission profile.

The system causes the user of the mobile device to be prompted to grant the likely permissions (step 408). In some cases, the user may have already granted some of the likely permissions, e.g., when submitting an earlier request or at download or install time of the virtual assistant application. If any of the permissions have already been granted, the system can refrain from prompting the user to grant those permissions again or can identify in the prompt the permissions that will likely be necessary but have already been granted and therefore do not need to be granted again.

FIG. 5 is a flowchart of an example process 500 for training a permission profile machine learning model. For convenience, the process 500 will be described as being performed by a system of one or more computers, located in one or more locations, and programmed appropriately in accordance with this specification. For example, a predictive permissioning system, e.g., the predictive permissioning system 100 of FIG. 1, appropriately programmed, can perform the process 500.

The system receives data identifying tasks that have been performed on behalf of users of the virtual assistant application (step 502). For example, the system can access logs of performed tasks to identify the tasks and to obtain data characterizing each task, i.e., data that is of the same type as the inputs to the permission-specific machine learning model.

The system determines, for each identified performed task, the permission profile that should be identified as the best-fitting permission profile by the permission profile machine learning model (step 504).

For example, the system can determine, as described above with reference to FIG. 3, which permissions were required to carry out the task. The system can then determine which permission profile most closely matches the required permissions and classify the most closely matching permission profile as the best-fitting permission profile for the task.

The system can determine which permission profile most closely matches the required permissions in any of a variety of ways. For example, the system can consider the permission profile that includes the most required permissions to be the most closely matching profile. As another example, the system can consider the permission profile that has the highest percentage of its permissions also being required permissions to be the most closely matching profile.

The system trains the permission profile machine learning model on the performed tasks to optimize an objective function that measures an error between the profile scores generated by the model for the performed tasks and the permission profiles that should be identified as the best-fitting permission profiles for the performed tasks (step 506).

The system can train the permission-specific machine learning model to optimize the objective function using an appropriate machine learning training technique for the type of model. For example, when the model is a feedforward neural network, the system can train the neural network using a stochastic gradient descent technique. As another example, when the model is a recurrent neural network, the system can train the recurrent neural network using a backpropagation through time training technique or a backpropagation through time with Connectionist Temporal Classification technique.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In this specification, the term “database” will be used broadly to refer to any collection of data: the data does not need to be structured in any particular way, or structured at all, and it can be stored on storage devices in one or more locations.

Similarly, in this specification the term “engine” will be used broadly to refer to a software based system or subsystem that can perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving a request from a user of a mobile device, the request defining a task to be carried out on behalf of the user by a virtual assistant application installed on the mobile device;
determining, by processing data characterizing the task using one or more machine learning models, one or more mobile device permissions that will likely need to be granted by the user in order for the virtual assistant application to carry out the task; and
causing a prompt to be presented on the mobile device that allows the user to grant the one or more permissions.

2. The method of claim 1, wherein determining one or more mobile device permissions comprises:
processing data characterizing the task using each of a plurality of permission-specific machine learning models,
wherein each permission-specific machine learning model corresponds to a different mobile device permission, and
wherein each permission specific-machine learning model has been trained to receive the data characterizing the task and to process the data characterizing the task to generate a permission score that represents a likelihood that the corresponding mobile device permission will need to be granted by the user in order for the virtual assistant application to carry out the task; and
selecting, based on the permission scores for the corresponding mobile device permissions, one or more of the corresponding mobile device permissions as mobile device permissions that will likely need to be granted by the user.

3. The method of claim 2, further comprising training each of the plurality of permission-specific machine learning models, comprising, for each permission-specific machine learning model:
identifying tasks that have been carried out on behalf of users;
determining, for each performed task, whether the corresponding mobile device permission was required to carry out the task; and
training the permission-specific machine learning model to generate accurate permission scores for the corresponding mobile device permission using, as positive training examples, the performed tasks that required the permission to be granted and, as negative examples, the performed tasks that did not require the permission to be granted.

4. The method of claim 3, wherein determining, for each performed task, whether the corresponding mobile device permission was required to carry out the task, comprises:
determining, from metadata associated with the performed task, whether the corresponding mobile device permission was required to carry out the task.

5. The method of claim 1, wherein determining one or more mobile device permissions comprises:
processing data characterizing the task using a permission profile machine learning model,
wherein the permission profile machine learning model has been trained to process the data characterizing the task to generate a respective profile score for each permission profile in a set of permission profiles,
wherein each permission profile includes a different combination of permissions, and
wherein the respective profile score for each of the permission profiles represents a likelihood that the permission profile most accurately reflects the permissions that will be necessary to carry out the task; and
determining, based on the profile scores, which permission profile most accurately reflects the permissions that will be necessary to carry out the task.

6. The method of claim 5, further comprising training the permission profile machine learning model, comprising:
identifying tasks that have been carried out on behalf of users;
determining, for each performed task, the permission profile that should be identified as a best-fitting permission profile by the permission profile machine learning model; and
training the permission profile machine learning model to generate accurate profile scores on the performed tasks.

7. The method of claim 1, wherein the data characterizing the task comprises text of the request submitted by the user.

8. A system comprising one or more computers and one or more storage devices storing instructions that when executed by the one or more computers cause the one or more computers to perform operations comprising:
receiving a request from a user of a mobile device, the request defining a task to be carried out on behalf of the user by a virtual assistant application installed on the mobile device;
determining, by processing data characterizing the task using one or more machine learning models, one or more mobile device permissions that will likely need to be granted by the user in order for the virtual assistant application to carry out the task; and
causing a prompt to be presented on the mobile device that allows the user to grant the one or more permissions.

9. The system of claim 8, wherein determining one or more mobile device permissions comprises:
processing data characterizing the task using each of a plurality of permission-specific machine learning models,
wherein each permission-specific machine learning model corresponds to a different mobile device permission, and
wherein each permission specific-machine learning model has been trained to receive the data characterizing the task and to process the data characterizing the task to generate a permission score that represents a likelihood that the corresponding mobile device permission will need to be granted by the user in order for the virtual assistant application to carry out the task; and
selecting, based on the permission scores for the corresponding mobile device permissions, one or more of the corresponding mobile device permissions as mobile device permissions that will likely need to be granted by the user.

10. The system of claim 9, the operations further comprising training each of the plurality of permission-specific machine learning models, comprising, for each permission-specific machine learning model:
identifying tasks that have been carried out on behalf of users;
determining, for each performed task, whether the corresponding mobile device permission was required to carry out the task; and
training the permission-specific machine learning model to generate accurate permission scores for the corresponding mobile device permission using, as positive training examples, the performed tasks that required the permission to be granted and, as negative examples, the performed tasks that did not require the permission to be granted.

11. The system of claim 10, wherein determining, for each performed task, whether the corresponding mobile device permission was required to carry out the task, comprises:
determining, from metadata associated with the performed task, whether the corresponding mobile device permission was required to carry out the task.

12. The system of claim 8, wherein determining one or more mobile device permissions comprises:
processing data characterizing the task using a permission profile machine learning model,
wherein the permission profile machine learning model has been trained to process the data characterizing the task to generate a respective profile score for each permission profile in a set of permission profiles,
wherein each permission profile includes a different combination of permissions, and
wherein the respective profile score for each of the permission profiles represents a likelihood that the permission profile most accurately reflects the permissions that will be necessary to carry out the task; and
determining, based on the profile scores, which permission profile most accurately reflects the permissions that will be necessary to carry out the task.

13. The system of claim 12, the operations further comprising training the permission profile machine learning model, comprising:
identifying tasks that have been carried out on behalf of users;
determining, for each performed task, the permission profile that should be identified as a best-fitting permission profile by the permission profile machine learning model; and
training the permission profile machine learning model to generate accurate profile scores on the performed tasks.

14. The system of claim 8, wherein the data characterizing the task comprises text of the request submitted by the user.

15. One or computer storage media storing instructions that when executed by one or more computers cause the one or more computers to perform operations comprising:
receiving a request from a user of a mobile device, the request defining a task to be carried out on behalf of the user by a virtual assistant application installed on the mobile device;
determining, by processing data characterizing the task using one or more machine learning models, one or more mobile device permissions that will likely need to be granted by the user in order for the virtual assistant application to carry out the task; and
causing a prompt to be presented on the mobile device that allows the user to grant the one or more permissions.

16. The computer storage media of claim 15, wherein determining one or more mobile device permissions comprises:
processing data characterizing the task using each of a plurality of permission-specific machine learning models,
wherein each permission-specific machine learning model corresponds to a different mobile device permission, and
wherein each permission specific-machine learning model has been trained to receive the data characterizing the task and to process the data characterizing the task to generate a permission score that represents a likelihood that the corresponding mobile device permission will need to be granted by the user in order for the virtual assistant application to carry out the task; and
selecting, based on the permission scores for the corresponding mobile device permissions, one or more of the corresponding mobile device permissions as mobile device permissions that will likely need to be granted by the user.

17. The computer storage media of claim 16, the operations further comprising training each of the plurality of permission-specific machine learning models, comprising, for each permission-specific machine learning model:
identifying tasks that have been carried out on behalf of users;
determining, for each performed task, whether the corresponding mobile device permission was required to carry out the task; and
training the permission-specific machine learning model to generate accurate permission scores for the corresponding mobile device permission using, as positive training examples, the performed tasks that required the permission to be granted and, as negative examples, the performed tasks that did not require the permission to be granted.

18. The computer storage media of claim 17, wherein determining, for each performed task, whether the corresponding mobile device permission was required to carry out the task, comprises:
determining, from metadata associated with the performed task, whether the corresponding mobile device permission was required to carry out the task.

19. The computer storage media of claim 15, wherein determining one or more mobile device permissions comprises:
processing data characterizing the task using a permission profile machine learning model,
wherein the permission profile machine learning model has been trained to process the data characterizing the task to generate a respective profile score for each permission profile in a set of permission profiles,
wherein each permission profile includes a different combination of permissions, and
wherein the respective profile score for each of the permission profiles represents a likelihood that the permission profile most accurately reflects the permissions that will be necessary to carry out the task; and
determining, based on the profile scores, which permission profile most accurately reflects the permissions that will be necessary to carry out the task.

20. The computer storage media of claim 19, the operations further comprising training the permission profile machine learning model, comprising:
identifying tasks that have been carried out on behalf of users;
determining, for each performed task, the permission profile that should be identified as a best-fitting permission profile by the permission profile machine learning model; and
training the permission profile machine learning model to generate accurate profile scores on the performed tasks.
